(19) United States
(12) Patent Application Publication
(10) Pub. No.: US 2024/0411124 A1
(43) Pub. Date: Dec. 12, 2024

(54) Magnifying Display Device

(71) Applicant: E-LEAD ELECTRONIC CO., LTD., CHANGHUA (TW)

(72) Inventor: Stephen CHEN, CHANGHUA (TW)

(21) Appl. No.: 18/493,189

(22) Filed: Oct. 24, 2023

(30) Foreign Application Priority Data
Jun. 9, 2023 (TW) 112121515

(51) Int. Cl. G02B 25/00; G02B 7/182

(52) U.S. Cl. CPC G02B 25/007; G02B 7/182

(57) ABSTRACT

A magnifying display device includes a magnifying reflective mirror module configured to a load frame bracket. The magnifying reflective mirror module is provided with a reflective sheet to receive and reflect a projected image and a magnifying sheet to receive and magnify a reflected image from the reflective sheet. The reflective sheet is a dual-curved convex mirror or the magnifying sheet is a dual-curved concave mirror to provide a vertical defocus, enabling the reflected image being displayed in a vertical virtual image distance farther than in a horizontal virtual image distance, so that the reflected image is projected on an eyeball forming a defocused image in a vertical line-of-sight image area and a focused image in a horizontal line-of-sight image area.

### BACKGROUND

### Technical Field

The present disclosure is directed to a magnifying display device, especially a magnifying display device capable of correcting, controlling or delaying progression of myopia.

### Related Art

Due to popularization of electronic products such as smartphones and tablets, the prevalence of myopia in children increasing has become a problem faced by all countries. In addition to genetics, using eyes to focus on objects at a close distance for long periods is also one of the main causes of myopia.

Please refer to FIG. 1, there are many ways of myopia control, one of which is generally believed to be effective is to wear peripheral defocusing correction glasses. The center curvature of the lens 91 (peripheral myopia defocusing lens) of glasses is customized according to the vision of the wearer, so that the line-of-sight in the middle position is focused on the retina (that is, the focal area 921), enabling the wearer to see clearly. The microstructure of the peripheral area of the lens forms smaller curvature, so there is a longer focal length, so that the line-of-sight is focused in front of the retina (that is, the peripheral defocused area 922,) so the line-of-sight image 93 is focused earlier. If the defocus image is arranged around the peripheral area of the lens, only the image in the center of the lens will be clear, and the wearer's vision will be more focused, and the peripheral defocus image will not affect the life of the wearer.

The effect of peripheral myopia defocus on the prevention and control of myopia is derived from experiments on animals (apes), and has achieved good results. According to medical research, the retina has a phenomenon of focusing. When the line-of-sight is focused in front of the retina, there is a tendency for the retina to move forward, thereby counteracting the growth of eye axis, and the growth of eye axis is the main physiological change that constitutes permanent myopia.

Another method is to wear orthokeratology lenses. Orthokeratology lenses are capable of inhibiting myopia progression by using a similar principle. By wearing hard contact lenses at night when sleep, and use the shape of the lens to press the central part of the cornea to make the center of the cornea produce a temporary physical deformation. Clear vision maintains for a day or two after the hard contact lenses are removed by the wearer in the daytime. The reason that it not only can obtain short-term clear vision, but also delay the myopia progression is that the shaping lens only shapes the central part of the cornea, the peripheral cornea still maintains the original myopic state, so that the peripheral line-of-sight is focused in the front of the retina.

Orthokeratology lenses have the effect of delaying the myopia progression, which also indirectly proves that peripheral myopia defocus does have the effect of delaying the myopia progression.

### SUMMARY

The present disclosure provides a magnifying display device capable of zooming out images of near objects and reducing frequencies of using eyes to focus on objects at a close distance for long periods. In addition, when the magnifying device is in use, an effect of vertical defocus is provided to delay growth of eye axis and achieve prevention and control of myopia.

The magnifying display device of the present disclosure is not a display device close to the eyeball. Instead, it utilizes the vertical defocus, so that half of a line-of-sight is focused on a retina, and the other half is focused in front of the retina, so as to partially achieve the effect of vertical defocus, enabling a vertical virtual image distance of the magnifying display device significantly to be farther than a horizontal virtual image distance of the magnifying display device. When the eyeball focuses on the horizontal virtual image, the line-of-sight image will be focused on the retina; when the eyeball focuses on the vertical virtual image, the vertical line-of-sight image will be focused in front of the retina.

The present disclosure is directed to a magnifying display device including a magnifying reflective mirror module configured to a load frame bracket. The magnifying reflective mirror module includes a reflective sheet and a magnifying sheet. The reflective sheet is configured to receive a projected image and then reflect the projected image. The magnifying sheet is configured to receive and then magnify a reflected image from the reflective sheet. The reflective sheet is a dual-curved convex mirror or the magnifying sheet is a dual-curved concave mirror to provide a vertical defocus, enabling the reflected image to be displayed in a vertical virtual image distance which is farther than in a horizontal virtual image distance. The reflected image is projected on an eyeball forming a defocused image in a vertical line-of-sight image area and a focused image in a horizontal line-of-sight image area.

In some embodiment, the horizontal virtual image distance where the reflective sheet and the magnifying sheet reflect the projected image sequentially is defined as VIDh. The vertical virtual image distance where the reflective sheet and the magnifying sheet reflect the projected image sequentially is defined as VIDv. A severity of an astigmatism of the projected image between the vertical direction and the horizontal direction is defined as a.

$$α = \frac{1}{VIDh} - \frac{1}{VIDv} , 0.07 ≦ α ≦ 0.13$$

In some embodiment, a nip angle between the reflective sheet and the magnifying sheet ranges between 24°˜32°.

In some embodiment, a height ratio of the magnifying sheet to the reflective sheet ranges between 1:1.2 and 1:1.5.

In some embodiment, the magnifying sheet is a dual-curved concave mirror. The magnifying sheet is provided with a vertical curvature greater than a horizontal curvature. The reflective sheet herein is a flat mirror or a convex mirror.

In some embodiment, the reflective sheet is a dual-curved convex mirror. The reflective sheet is provided with a vertical curvature less than a horizontal curvature. The magnifying sheet herein is a concave mirror.

In some embodiment, the magnifying reflective mirror module further includes a reverse frame. One end of the reverse frame is connected to an upper edge of the reflective sheet, and the other end of the reverse frame is connected to a lower edge of the magnifying sheet.

In some embodiment, the load frame bracket includes an arm set and a fixed base. One end of the arm set is connected to the magnifying reflective mirror module, and the other end of the arm set is connected to the fixed base.

In some embodiment, the arm set further includes a first arm, a second arm, a first shaft and a second shaft. One end of the first arm is connected to the fixed base, and the other end of the first arm is connected to the first shaft. One end of the second arm is connected to the second shaft, and the other end of the second arm is connected to the first shaft.

In some embodiment, the arm set and the fixed base are provided with a third shaft therebetween.

### BRIEF DESCRIPTION OF THE DRAWINGS

FIG. 1 is a schematic diagram of peripheral defocus control lenses;

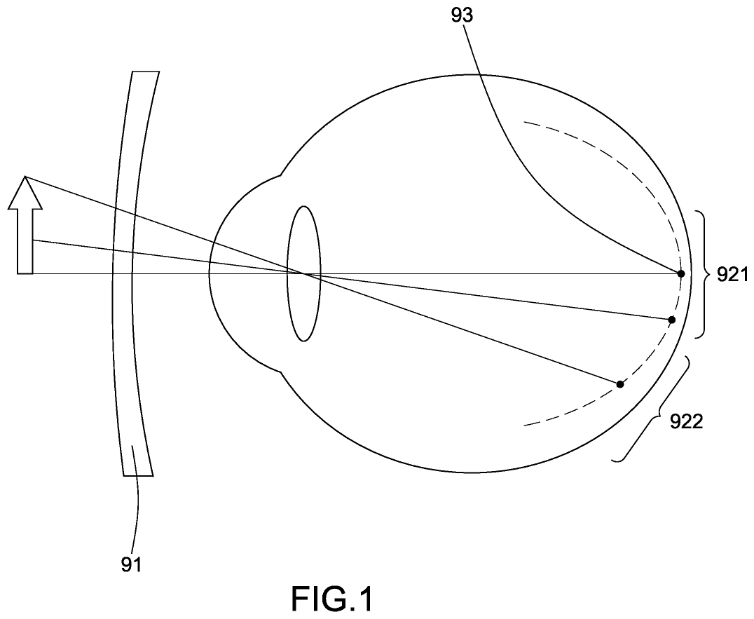

FIG. 2 is a schematic diagram of a structure of a magnifying display device according to some embodiment of the present disclosure;

FIG. 3a and FIG. 3b are schematic diagrams of the magnifying display device in use;

FIG. 4 is a schematic diagram of an optical path of the magnifying display device;

FIG. 5 is a schematic diagram of angle arrangements of a magnifying sheet and a reflective sheet.

### DETAILED DESCRIPTION

In order to illustrate embodiments, structures and effects of the present disclosure more clearly, the embodiments are provided with drawings as below.

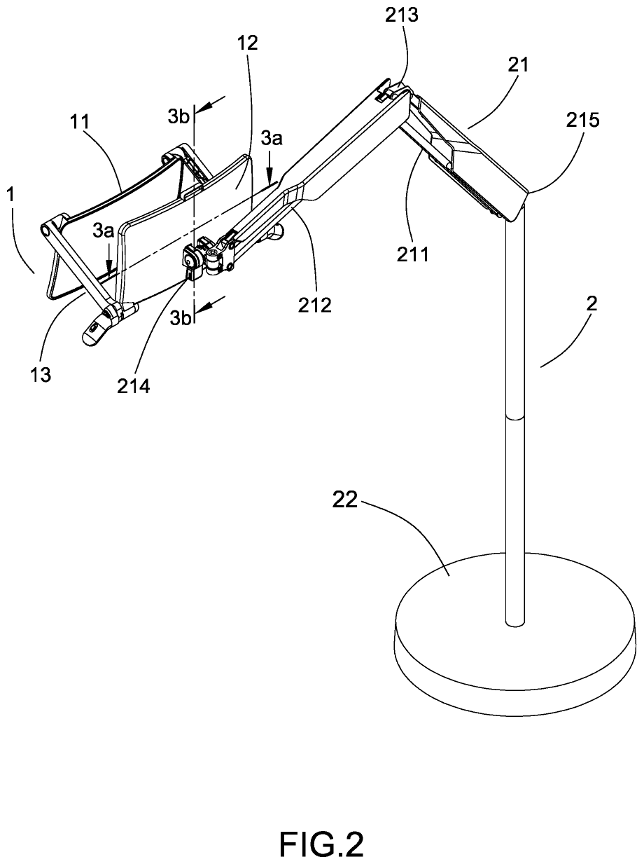

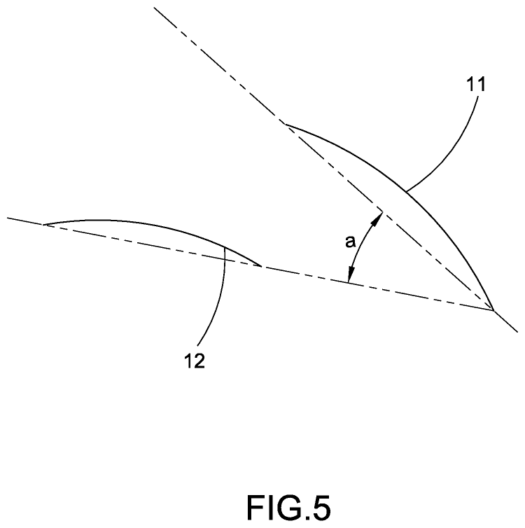

Please refer to FIG. 2˜FIG. 5, the present disclosure provides an embodiment of a magnifying display device comprising a magnifying reflective mirror module 1 configured to a load frame bracket 2.

The load frame bracket 2 includes an arm set 21 and a fixed base 22. The arm set 21 and the fixed base 22 are connected by a third shaft 215. One end of the arm set 21 is connected to the magnifying reflective mirror module 1, and the other end of the arm set 21 is connected to the fixed base 22. The arm set 21 includes a first arm 211, a second arm 212, a first shaft 213, and a second shaft 214. One end of the first arm 211 is connected to the fixed base 22, and the other end of the first arm 211 is connected to the first shaft 213. One end of the second arm 212 is connected to the second shaft 214, and the other end of the second arm 212 is connected to the first shaft 213, enabling the second shaft 214 to be connected to the magnifying reflective mirror module 1.

The magnifying reflective mirror module 1 includes a reflective sheet 11, a magnifying sheet 12 and a reverse frame 13. One end of the reverse frame 13 is connected to an upper edge of the reflective sheet 11, and the other end of the reverse frame 13 is connected to a lower edge of the magnifying sheet 12. In some embodiment, the reflective sheet 11 is served to receive a projected image and then reflect the projected image. In some embodiment, the magnifying sheet 12 is served to receive a reflected image from the reflective sheet 11, display and then magnify the reflected image.

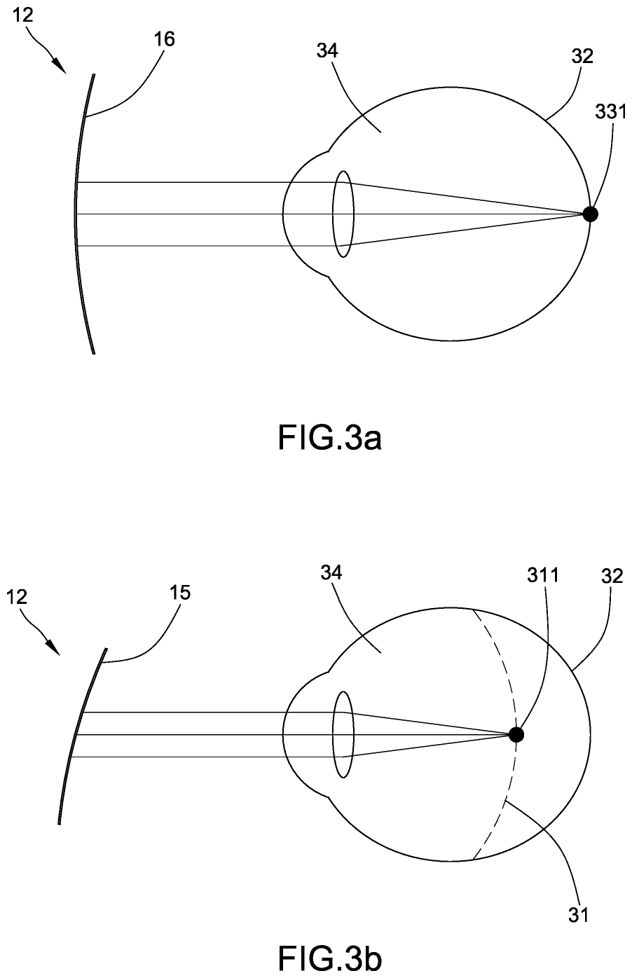

In some embodiment, the reflective sheet 11 is dual-curved convex mirror, a vertical curvature of the reflective sheet 11 being less than a horizontal curvature of the reflective sheet 11, the magnifying sheet 12 herein is a concave mirror. In some embodiment, the magnifying sheet 12 is a dual-curved concave mirror, a vertical curvature of the magnifying sheet 12 being greater than a horizontal curvature of the magnifying sheet 12, the reflective sheet 11 herein is a flat mirror or a convex mirror, enabling the reflected image to project on an eyeball forming a defocused image in a vertical line-of-sight image area, enabling the reflected image to project on the eyeball forming a focused image in a horizontal line-of-sight image area. The illustration of the present disclosure takes the magnifying sheet 12, a dual-curved concave mirror, as an example as shown in FIG. 3a and FIG. 3b.

The aforementioned dual-curvature means a curvature along a vertical axis 15 and a curvature along a horizontal axis 16 are defined individually, for users, the reflected image being aligned with (or closer to) a horizontal axis will be focused on the retina 32. Therefore, half of the reflected image forms a line-of-sight image 33 of a vitreous body 34 will be focused on the retina 32, and the other half will be focused in front of the retina 32. In other words, a part of the magnifying sheet 12 achieves the effect of the vertical defocus.

The aforementioned vertical defocus means a virtual image distance of the reflected image on the vertical axis 15 being significantly farther than a virtual image distance of the reflected image on the horizontal axis 16. When the eyeball focuses on the virtual image distance on the horizontal axis 16, a line-of-sight image 331 will be focused on the retina 32 (as shown in FIG. 3a) forming a focused image, a line-of-sight image 311 of the vertical axis 15 being on an imaging position of the vitreous body 34 (vertical line-of-sight image area 31) will be focused in front of the retina 32 (as shown in FIG. 3b) forming a defocused image.

Modes of human eyes adjusting imaging of object images can be divided into convergence reflection and crystal adjustment. The convergence effect of both eyes will cause human eyes to produce a single image on visual impression. When both eyes meet, and the line-of-sight of both eyes form a nip angle. When observing a distant object, the nip angle of convergence between the both eyes is smaller. When observing a near object, the nip angle of convergence between the both eyes is greater. Crystal adjustments are focus adjustments of crystals of the both eyes individually. When observing a distant object, the crystal becomes thinned, and when observing a near object, the crystal becomes thickened, enabling the line-of-sight at different distances to be focused on the retina 32. Convergence reflection and crystal adjustment are conducted simultaneously. Usually, the crystal will adjust the focal length of imaging according to the nip angle of convergence. The both eyes are located at different positions in the horizontal direction, so the convergence reflection is only related to the visual distance in the horizontal direction, so the horizontal line-of-sight image will be focused on the retina 32.

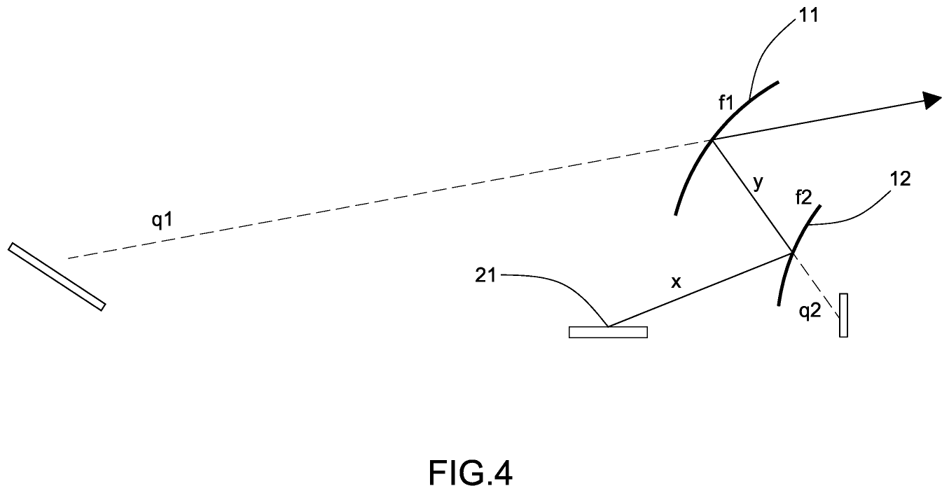

Please refer to FIG. 4, if the magnifying sheet 12 is a concave mirror, the reflective sheet 12 is a convex mirror, the calculation formula of imaging zoom-out is as follows:

The virtual image imaging formula of the magnifying sheet 12 is according to the concave mirror imaging principle:

$$\frac{1}{q 1} = \frac{1}{p 1} - \frac{1}{f 1}$$

wherein f1 is focal length; q1 is image distance, p1 is object distance.

The imaging formula of the reflective sheet 11 is according to the convex mirror imaging principle:

$$\frac{1}{q 2} = \frac{1}{p 2} + \frac{1}{f 2}$$

wherein f2 is focal length; q2 is object distance, p1 is image distance,
wherein p1=y+q2 and p2=x.

If the reflective sheet 12 is a flat mirror, f2 is oo, the virtual image distance formula is as follows:

$$q 1 = \frac{f 1 x y + f 1 f 2 ( x + y )}{f 1 f2 + f 1 x - x y - f 2 ( x + y )}$$

The image distance q1 is calculated by using the horizontal curvature of the focal length f2 of the reflective sheet 11 and the focal length f1 of the magnifying sheet 12 equals to the horizontal virtual image distance VIDh. The image distance q1 is calculated by using the vertical curvature of the focal length f2 of the reflective sheet 11 and the focal length f1 of the magnifying sheet 12 equals to the vertical virtual image distance VIDv, that is, the distance between the vertical the line-of-sight image area 31 and the retina 32.

The vertical line-of-sight image area 31 of the magnifying display device is focused in front of the retina 32 instead of on the retina 32. If the vertical line-of-sight image area 31 is too far away from the retina 32, the image entering the eye will be blurred vertically, and the horizontal lines will be blurry (like astigmatism), so there is only a limited distance spaced from the horizontal focal length to maintain the visual quality, but the distance needs to be great enough to exert the effect of the vertical defocus.

To measure the severity of astigmatism caused by the focal length difference between the vertical axis and the horizontal axis, the following value a is generally utilized to measure,

$$α = \frac{1}{VIDh} - \frac{1}{VIDv}$$

wherein VIDh is the horizontal virtual image distance (meters), VIDv is the vertical virtual image distance (meters), and VIDh and VIDv can be calculated using the calculation formula of zooming out.

In the optical system, as long as α≤0.13, basically no astigmatism is observed, but the vertical defocus distance is relatively short (the distance between the vertical line-of-sight and the retina 32,) and is focused about 0.07 mm in front of the retina 32. α may satisfy the following formula.

$$0.07 \leq α \leq 0. 13$$

The present disclosure provides an embodiment, the value of VIDv is greater than VIDh, so the vertical magnification is greater than the horizontal magnification. At this point, the image of the object in a mirror will be pulled up, resulting in distortion of aspect ratio. It is necessary to adjust the nip angle between the magnifying sheet 12 and the reflective sheet 11 to avoid the problem of aspect ratio distortion. In some embodiment, the nip angle between the magnifying sheet 12 and the reflective sheet 11 is greater, the aspect ratio of the image in the mirror is smaller, and vice versa. Generally, the nip angle a between the reflective sheet 11 and the magnifying sheet 12 ranges between 24°˜32° (please refer to FIG. 5.)

The distortion of the aspect ratio of the image in the mirror is compensated by adjusting the nip angle a between the magnifying sheet 12 and the reflective sheet 11 to be greater, however when the nip angle between the magnifying sheet 12 and the reflective sheet 11 is greater, the height of the reflective sheet 11 observed in the magnifying sheet 12 will be lower, which is equivalent to wasting a vertical field of view, so it is necessary to increase the ratio of the height of the reflective sheet 11 to the height of the magnifying sheet 12, which generally ranges between 1:1.2 and 1:1.5.

What is claimed is:

1. A magnifying display device comprising:
a magnifying reflective mirror module, being provided with a reflective sheet and a magnifying sheet;
wherein the reflective sheet is configured to receive a projected image and then reflect the projected image;
wherein the magnifying sheet is configured to receive and then magnify a reflected image from the reflective sheet; and
a load frame bracket, wherein the magnifying reflective mirror module is configured to the load frame bracket;
wherein the reflective sheet is a dual-curved convex mirror or the magnifying sheet is a dual-curved concave mirror to provide a vertical defocus;
wherein the reflected image displayed in a vertical virtual image distance is farther than in a horizontal virtual image distance;
wherein the reflected image is projected on an eyeball forming a defocused image in a vertical line-of-sight image area and a focused image in a horizontal line-of-sight image area.

2. The magnifying display device of claim 1, wherein the horizontal virtual image distance where the reflective sheet and the magnifying sheet reflect the projected image sequentially is defined as VIDh; wherein the vertical virtual image distance where the reflective sheet and the magnifying sheet reflect the projected image sequentially is defined as VIDv; wherein a severity of an astigmatism of the projected image between the vertical direction and the horizontal direction is defined as α.
$$α = \frac{1}{VIDh} - \frac{1}{VIDv} , 0.07 ≦ α ≦ 0.13$$

3. The magnifying display device of claim 1, wherein the reflective sheet and the magnifying sheet are provided with a nip angle therebetween; wherein the nip angle ranges between 24°˜32°.

4. The magnifying display device of claim 1, wherein a height ratio of the magnifying sheet to the reflective sheet ranges between 1:1.2 and 1:1.5.

5. The magnifying display device of claim 1, wherein the magnifying sheet is a dual-curved concave mirror; wherein the magnifying sheet is provided with a vertical curvature and a horizontal curvature; wherein the vertical curvature is greater than the horizontal curvature; wherein the reflective sheet is a flat mirror or a convex mirror.

6. The magnifying display device of claim 1, wherein the reflective sheet is a dual-curved convex mirror; wherein the reflective sheet is provided with a vertical curvature and a horizontal curvature; wherein the vertical curvature is less than the horizontal curvature; wherein the magnifying sheet is a concave mirror.

7. The magnifying display device of claim 1, wherein the magnifying reflective mirror module further includes a reverse frame with two ends; wherein the reflective sheet is provided with an upper edge and the magnifying sheet is provided with a lower edge; wherein one end of the reverse frame is connected to the upper edge of the reflective sheet, and the other end of the reverse frame is connected to the lower edge of the magnifying sheet.

8. The magnifying display device of claim 1, wherein the load frame bracket includes an arm set and a fixed base; wherein the arm set is provided with two ends; wherein one end of the arm set is connected to the magnifying reflective mirror module, and the other end of the arm set is connected to the fixed base.

9. The magnifying display device of claim 8, wherein the arm set further includes a first arm, a second arm, a first shaft and a second shaft; wherein the first arm is provided with two ends and the second arm is provided with two ends; wherein one end of the first arm is connected to the fixed base, and the other end of the first arm is connected to the first shaft; wherein one end of the second arm is connected to the second shaft, and the other end of the second arm is connected to the first shaft.

10. The magnifying display device of claim 9, wherein the arm set and the fixed base are provided with a third shaft therebetween.
